(19) United States
(12) Patent Application Publication
(10) Pub. No.: US 2016/0188841 A1
(43) Pub. Date: Jun. 30, 2016

(54) MEDICAL SUPPORT APPARATUS, SYSTEM AND METHOD FOR MEDICAL SERVICE

(71) Applicant: FUJIFILM Corporation, Tokyo (JP)

(72) Inventors: Yuya KUDO, Tokyo (JP); Satoshi UEDA, Tokyo (JP); Hironori MATSUMASA, Tokyo (JP); Ryosuke USAMI, Tokyo (JP); Takamasa YAGUCHI, Tokyo (JP); Yasunori OHTA, Tokyo (JP)

(73) Assignee: FUJIFILM Corporation, Tokyo (JP)

(21) Appl. No.: 14/964,590

(22) Filed: Dec. 10, 2015

(30) Foreign Application Priority Data
Dec. 26, 2014 (JP) 2014-265150

(51) Int. Cl. G06F 19/00

(52) U.S. Cl. CPC G06F 19/3481; G06F 19/322; G06F 19/3487

(57) ABSTRACT

A medical support apparatus outputs information of a medical service to a patient body. A page generator generates a schedule view page to display a medical care schedule (patient workflow) constituted by arranging plural medical services in a time sequence. Estimated remaining time is displayed in the schedule view page, the estimated remaining time being time from a current time point until an estimated time point of at least one particular medical service selected from the medical services in the medical care schedule. Preferably, a first medical care schedule has a medical service to be performed in case the particular medical service is in time until the estimated time point. A second medical care schedule has a medical service to be performed in case of non-occurrence of the particular medical service in time until the estimated time point.

### CROSS-REFERENCE TO RELATED APPLICATION

This application claims priority under 35 USC 119 from Japanese Patent Application No. 2014-265150, filed 26 Dec. 2014, the disclosure of which is incorporated by reference herein.

### BACKGROUND OF THE INVENTION

1. Field of the Invention

The present invention relates to a medical support apparatus, system and method for a medical service. More particularly, the present invention relates to a medical support apparatus, system and method for a medical service, in which medical services can be performed in a suitable manner according to a medical care schedule (patient workflow).

2. Description Related to the Prior Art

Medical computer systems of various types are suggested in the medical field for supporting medical care. For example, JP-A 2014-063214 discloses a medical support system for receiving inputs of symptoms or the like of a patient body, and for automatically creating and displaying a medical care schedule (patient workflow) for the medical care. The medical care schedule is constituted by plural medical services arranged in a time sequence for the patient body. Examples of the medical services are patient care, examination, diagnosis, treatment, surgery, preparation for the patient care, and the like. In the medical care schedule, time and a sequence of performing the medical services are determined. Creating the medical care schedule makes it possible to share information of the medical care schedule between staff members of the hospital facility, inclusive of a doctor, nurses and other caregivers.

In relation to the various medical services constituting a medical care schedule created by the medical support system in JP-A 2014-063214, a time point of performing each medical service is important. Should a medical service be performed with delay, serious problems will occur. For example, no effect of the medical service may be obtained. Risk to the patient body will be considerably high. Subsequent medical services may require suitable changes. Consequently, it is necessary to perform medical services by following the medical care schedule.

However, displaying a medical care schedule as suggested in JP-A 2014-063214 is insufficient for supporting the progress of the medical care schedule. There is no known improvement of the medical support system in view of such a problem.

### SUMMARY OF THE INVENTION

In view of the foregoing problems, an object of the present invention is to provide a medical support apparatus, system and method for a medical service, in which medical services can be performed in a suitable manner according to a medical care schedule (patient workflow).

In order to achieve the above and other objects and advantages of this invention, a medical support apparatus for outputting information of a medical service to a patient body is provided. A page generator generates a schedule view page to display a medical care schedule constituted by arranging plural medical services in a time sequence. The page generator further performs display processing to display estimated remaining time in the schedule view page, the estimated remaining time being time from a current time point until an estimated time point of at least one particular medical service selected from the medical services in the medical care schedule.

Preferably, the page generator changes a display form of the schedule view page according to the estimated remaining time.

Preferably, the page generator changes the display form of the schedule view page by changing a display form of a timeline representation.

Preferably, at least one predetermined time value is predetermined in association with a type of the particular medical service. The page generator changes the display form in case the estimated remaining time becomes equal to or less than the predetermined time value.

Preferably, furthermore, a notification device notifies message information in case the estimated remaining time becomes equal to the predetermined time value.

Preferably, the predetermined time value is constituted by plural time values between which an interval gradually decreases, and a number of times of notifying the message information increases with a decrease of the interval.

Preferably, the medical care schedule in the schedule view page is constituted by a first medical care schedule having a medical service to be performed in case the particular medical service is in time until the estimated time point, and a second medical care schedule having a medical service to be performed in case of non-occurrence of the particular medical service in time until the estimated time point.

Preferably, the page generator further performs display processing of first and second risk data in the schedule view page. The first risk data is data of risk to the patient body estimated in case the particular medical service is in time until the estimated time point. The second risk data is data of risk to the patient body estimated in case of non-occurrence of the particular medical service in time until the estimated time point.

Preferably, the first and second risk data are data of at least one of a survival rate of the patient body, a success rate of treatment of the patient body, and adverse effect of the treatment.

Preferably, information of the estimated remaining time is at least one of numerical information and graphical information.

Preferably, furthermore, a scheduler creates the medical care schedule according to a reference medical care schedule and information of the patient body.

Preferably, the reference medical care schedule is constituted by plural reference medical care schedules predetermined in a selectable manner in relation to at least one of a symptom, age, sex and medical history of the patient body.

Preferably, the medical care schedule is constituted by at least first to third medical care schedules. The first medical care schedule is used initially for performing the particular medical service. The second medical care schedule is used by changeover in case the particular medical service in the first medical care schedule is in time until the estimated time point. The third medical care schedule is used by changeover in case of non-occurrence of the particular medical service in the first medical care schedule in time until the estimated time point.

Preferably, furthermore, a clock device generates information of the current time point for input to the page generator.

Preferably, the page generator performs display processing of the schedule view page in a scrollable manner.

Also, a medical support system includes a client terminal apparatus. A medical support apparatus outputs information of a medical service to a patient body in response to a request input by the client terminal apparatus. In the medical support system, the medical support apparatus includes a page generator for generating a schedule view page to display a medical care schedule constituted by arranging plural medical services in a time sequence. The page generator further performs display processing to display estimated remaining time in the schedule view page, the estimated remaining time being time from a current time point until an estimated time point of at least one particular medical service selected from the medical services in the medical care schedule.

Also, a medical support method for outputting information of a medical service to a patient body is provided. A schedule view page is generated to display a medical care schedule constituted by arranging plural medical services in a time sequence. Estimated remaining time is displayed in the schedule view page, the estimated remaining time being time from a current time point until an estimated time point of at least one particular medical service selected from the medical services in the medical care schedule.

Consequently, medical services can be performed in a suitable manner according to a medical care schedule, because estimated remaining time important for a medical service can be displayed for ensured recognition to a user.

### BRIEF DESCRIPTION OF THE DRAWINGS

The above objects and advantages of the present invention will become more apparent from the following detailed description when read in connection with the accompanying drawings, in which:

FIG. 1 is a block diagram schematically illustrating a medical support system;

FIG. 2 is a data chart illustrating an electronic chart database;

FIG. 3 is a data chart illustrating an image database;

FIG. 4 is a data chart illustrating a schedule database;

FIG. 5A is a front elevation illustrating a screen view of a first medical care schedule (patient workflow);

FIG. 5B is a front elevation illustrating a screen view of a second medical care schedule;

FIG. 6 is a block diagram schematically illustrating circuit devices in a computer for use in a medical support server apparatus;

FIG. 7 is a block diagram schematically illustrating a client terminal apparatus;

FIG. 8 is a front elevation illustrating a scheduling page;

FIG. 9 is a front elevation illustrating a schedule view page;

FIG. 10 is a block diagram schematically illustrating the medical support server apparatus;

FIG. 11 is a flow chart illustrating display processing for the schedule view page;

FIG. 12 is a timing chart illustrating a preferred embodiment in which a display color of a timeline is changeable;

FIG. 13 is a front elevation, partially broken, illustrating a preferred embodiment having a time bar for estimated remaining time;

FIG. 14 is a block diagram schematically illustrating a preferred embodiment having a notification device;

FIG. 15 is a data chart illustrating a preferred embodiment in which risk data are associated with medical care schedules; and

FIG. 16 is a front elevation illustrating a schedule view page.

### DETAILED DESCRIPTION OF THE PREFERRED EMBODIMENT(S) OF THE PRESENT INVENTION

### First Embodiment

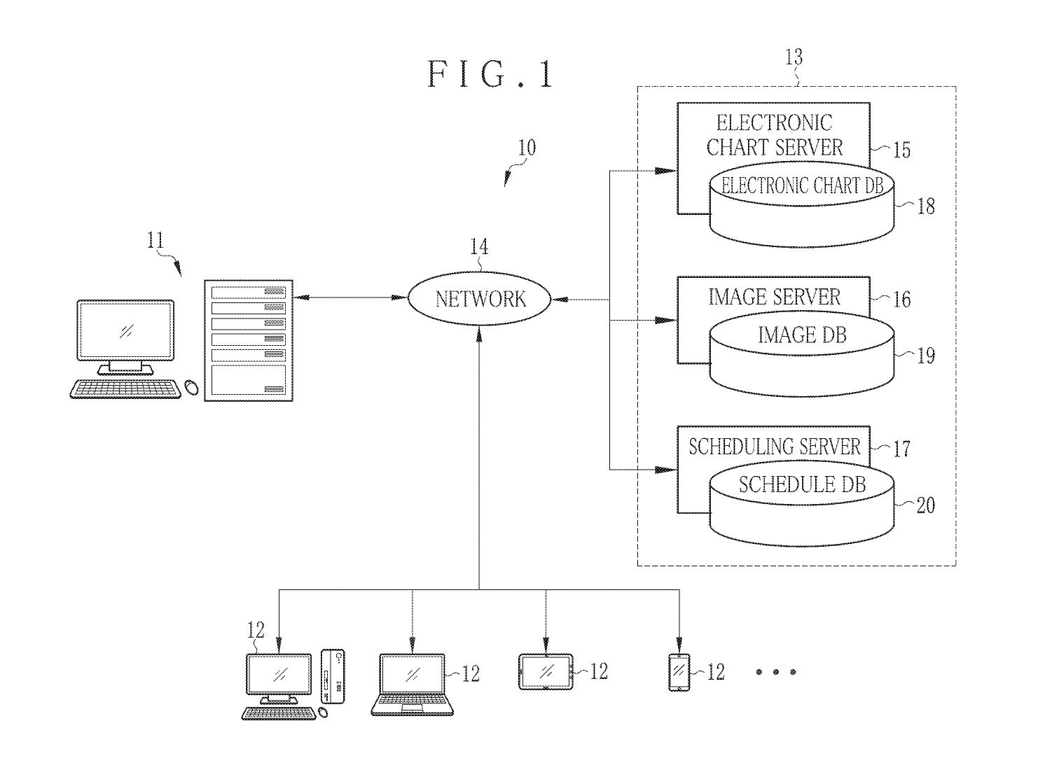

In FIG. 1, a medical support system 10 is a computer system for supporting medical services performed in a hospital facility, such as a clinic, hospital and the like. The medical support system 10 includes a medical support server apparatus 11 as medical support apparatus, a client terminal apparatus 12 and a server cluster 13. A network 14 interconnects those apparatuses communicably. An example of the network 14 is a LAN or local area network installed in the hospital facility.

The server cluster 13 includes an electronic chart server apparatus 15, an image server apparatus 16 and a scheduling server apparatus 17. An electronic chart database 18 or electronic chart DB is combined with the electronic chart server apparatus 15. The image server apparatus 16 is a PACS server according to the PACS or Picture Archiving and Communication System. An image database 19 or image DB is combined with the image server apparatus 16. A schedule database 20 or schedule DB is combined with the scheduling server apparatus 17. Each of the electronic chart database 18, the image database 19 and the schedule database 20 is a database in which search is possible with such a query as a case ID or case identification data of a patient body.

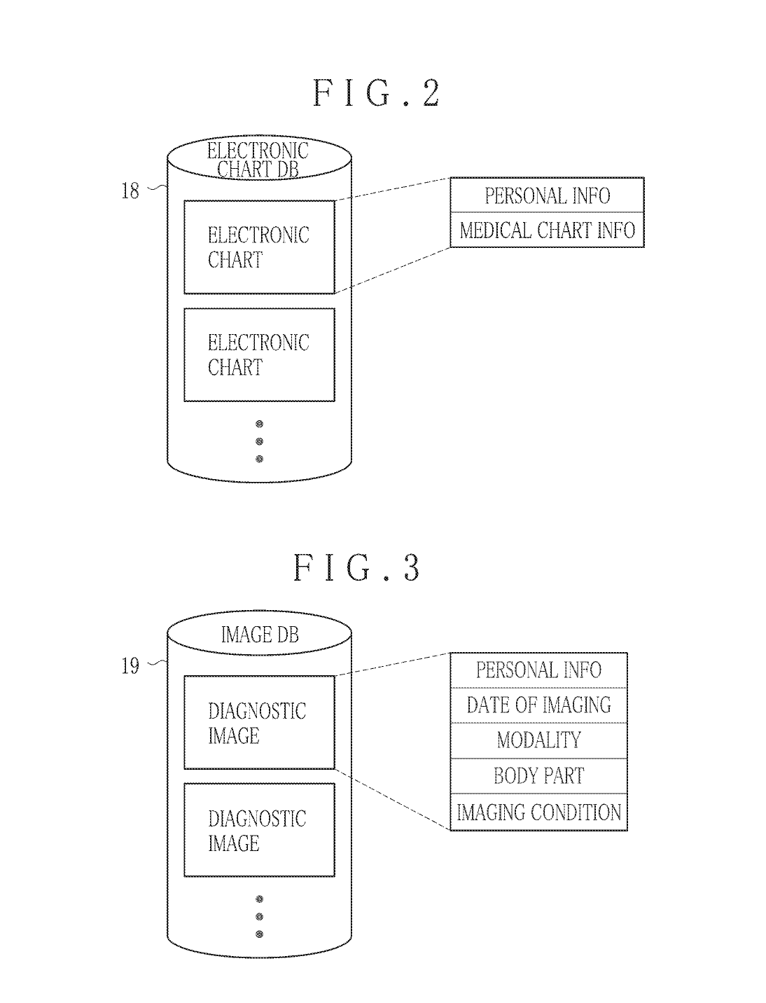

In FIG. 2, plural electronic charts are stored in the electronic chart database 18. The electronic charts are produced in association with patient bodies. Each of the electronic charts has personal information and medical chart information (clinical information). The personal information includes the patient's name, case ID, age and sex. The medical chart information includes a symptom name of a symptom during or after medical care, date and time of clinical onset of the symptom, staff members (caregivers), progress notes of questionnaire, examination and diagnosis, treatment information of treatment, surgery and the like, findings, results of diagnosis, and the like. The staff members include a doctor, nurse, technician of examination (radiologist), and the like. Examples of the results of the diagnosis include address information of an address (storage location) of a diagnostic image assuming that the diagnostic image is included in the results of the examination.

In FIG. 3, the image database 19 stores diagnostic images formed by medical imaging, such as X-ray imaging and CT (computed tomography). Various data are associated with the diagnostic images, such as personal information of the patient, date of imaging, modality, body part, imaging condition and the like.

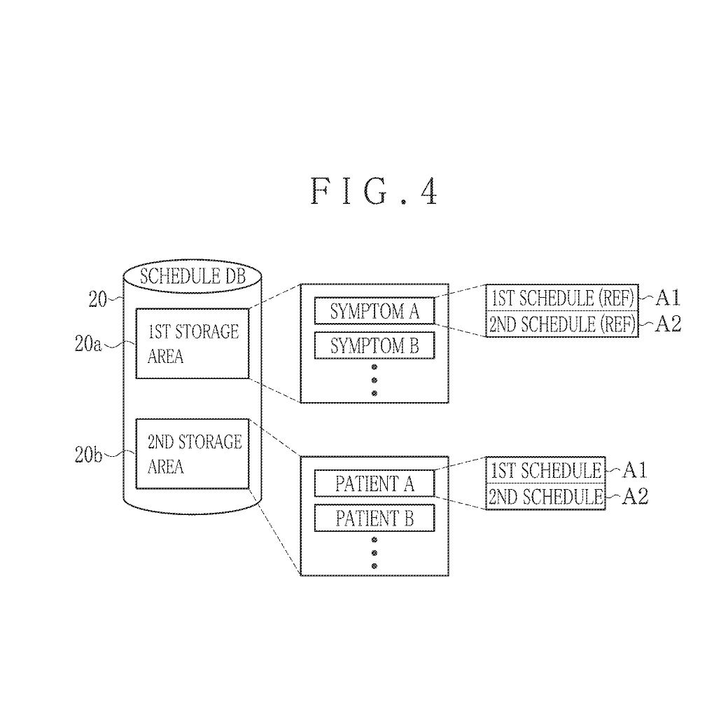

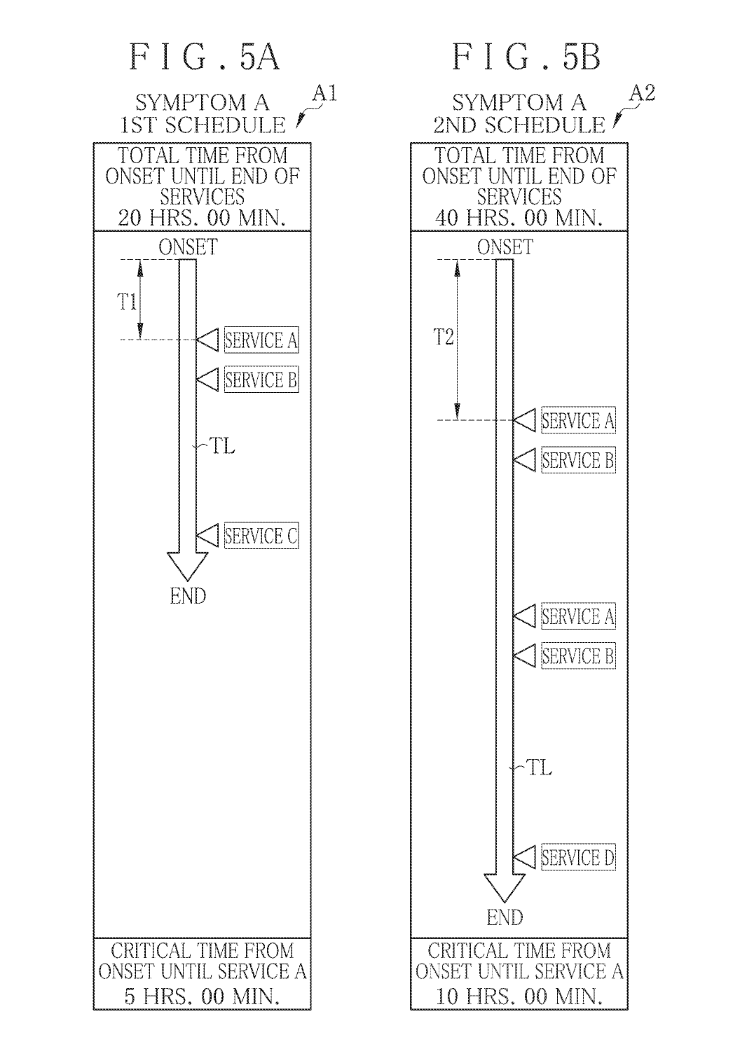

In FIG. 4, the schedule database 20 includes a first storage area 20a and a second storage area 20b or database components. Medical care schedules (patient workflows) are stored in the first and second storage areas 20a and 20b. Each of the medical care schedules is constituted by medical services arranged sequentially on a timeline TL of FIG. 5. The first storage area 20a stores reference medical care schedules for respective symptoms for use as a reference to create a new medical care schedule. The medical care schedules for the symptoms stored in the first storage area 20a include first medical care schedules and second medical care schedules. The first medical care schedules are characterized in priority to rapidity. The second medical care schedules are characterized in priority to sufficient time. In short, two reference medical care schedules are stored for each one of the symptoms in the first storage area 20a.

In FIG. 5A, a first medical care schedule A1 (patient workflow) for a symptom A is to perform a medical service A (drug administration), medical service B (observation of progress) and medical service C (simple examination), to complete all the medical services from the clinical onset of the symptom A in 20 hours. Note that it is necessary to perform the medical service A within critical time T1 (5 hours in the present embodiment) from the clinical onset for the purpose of medical service in the first medical care schedule A1.

In FIG. 5B, a second medical care schedule A2 (patient workflow) for the symptom A has two sets of the medical services A and B and then a medical service D, and is terminated in 40 hours from the clinical onset of the symptom A. An example of the medical service D is close examination. To this end, the medical service A at the first stage should be performed within critical time T2, for example, 10 hours.

Thus, the medical service in the first medical care schedule A1 is possible for the symptom A by performing the medical service A within the critical time T1 from the clinical onset. Assuming that the medical service A cannot be performed within the critical time T1 from the clinical onset, then the medical service in the first medical care schedule A1 is impossible and a medical service in the second medical care schedule A2 is performed. Let a time point after the critical time T1 from the clinical onset be an estimated time point for performing the medical service A. The first medical care schedule A1 is a medical care schedule after performing the medical service A in time for the estimated time point from the clinical onset of the symptom A. The second medical care schedule A2 is a medical care schedule after non-occurrence of the medical service A in time for the estimated time point from the clinical onset of the symptom A.

There are various differences in the features between the first and second medical care schedules A1 and A2. In the first medical care schedule A1, the medical service A to be performed initially must be performed rapidly. However, the number of subsequently required medical services is lower than that according to the second medical care schedule A2 because of the rapidity of the medical service A. Also, a medical service C as a final medical service is less complicated than a medical service D as a final medical service in the second medical care schedule A2.

Also, the second medical care schedule A2 is characterized in longer estimated remaining time until an initial medical service A than in the first medical care schedule A1. The initial medical service A can be performed with sufficient time for tasks. However, the number of subsequent medical services is higher than that according to the first medical care schedule A1, because the time from the clinical onset to the initial medical service A is comparatively long. It is necessary to perform additional tasks with time for the final examination or medical service D in comparison with the final examination or medical service C in the first medical care schedule A1.

In short, the features of the first medical care schedule A1 in comparison with the second medical care schedule A2 are the smaller number of required medical services, the medical services being not complicated, and the shorter time for the total time of the medical services. Thus, the rapidity (efficiency) in the first medical care schedule A1 is higher than in the second medical care schedule A2. The first medical care schedule A1 is a first selection option with higher priority.

The first and second medical care schedules A1 and A2 for the symptom A have been described heretofore. For other symptoms stored in the first storage area 20a, first and second medical care schedules are predetermined for each symptom. The first medical care schedule is a medical care schedule for a medical service with rapidity by rapidly performing an initial medical service to the corresponding symptom. In the second medical care schedule, an initial medical service can be performed with sufficient time. However, its rapidity is lower than in the first medical care schedule.

In case a patient is transported to a hospital facility, or in case a new disease or injury occurs to an in-patient in the hospital facility to require a new medical service, then input data of the patient are input to create a medical care schedule for the patient body, the input data including personal information, symptom information, staff member information and the like. See FIG. 4. The symptom information includes a name of the symptom and a date and time of a clinical onset. The staff member information includes a hospital department, medical staff members (caregivers) and the like. This medical care schedule is created by selectively reading a medical care schedule from the first storage area 20a in association with the symptom of the patient body, and by associating the input data with the read medical care schedule. The created medical care schedule is written to the second storage area 20b.

Therefore, the medical care schedules stored in the second storage area 20b are medical care schedules for each patient body created by associating various data to the reference medical care schedules stored in the first storage area 20a according to symptoms (diseases, disorders and injuries), the various data including a patient name, case ID of the patient body, doctor name and the like. As the first and second medical care schedules are included in the reference medical care schedules stored in the first storage area 20a, medical care schedules to be stored in the second storage area 20b after creation for each patient body are in the form of having the first and second medical care schedules in the same manner as those in the first storage area 20a.

In FIG. 1, examples of the client terminal apparatus 12 are a desktop computer, notebook computer, tablet terminal, smart phone and the like. The client terminal apparatus 12 can be used exclusively by one doctor or operator as a staff member, or by plural staff members commonly in a hospital department, such as internal medicine, surgery, otolaryngology and ophthalmology. The client terminal apparatus 12 performs access to the electronic chart server apparatus 15, to produce an electronic chart or view the electronic chart. Also, the client terminal apparatus 12 performs access to the image server apparatus 16 to view a diagnostic image. The client terminal apparatus 12 performs access to the scheduling server apparatus 17 to create and view a medical care schedule.

The medical support server apparatus 11 is a medical support apparatus, which generates a medical support page for the above-described functions in the client terminal apparatus 12, and transmits the medical support page to the client terminal apparatus 12. The medical support server apparatus 11 receives access from the client terminal apparatus 12, and generates and transmits the medical support page according to input requests from the client terminal apparatus 12.

Each one of the medical support server apparatus 11, the client terminal apparatus 12, the electronic chart server apparatus 15, the image server apparatus 16 and the scheduling server apparatus 17 is constituted by a computer and programs installed therein. Examples of the computer are a personal computer, server computer, workstation and the like. The programs include control programs and application programs. The control programs are an Operating System (OS) and the like. The application programs are client programs, server programs and the like.

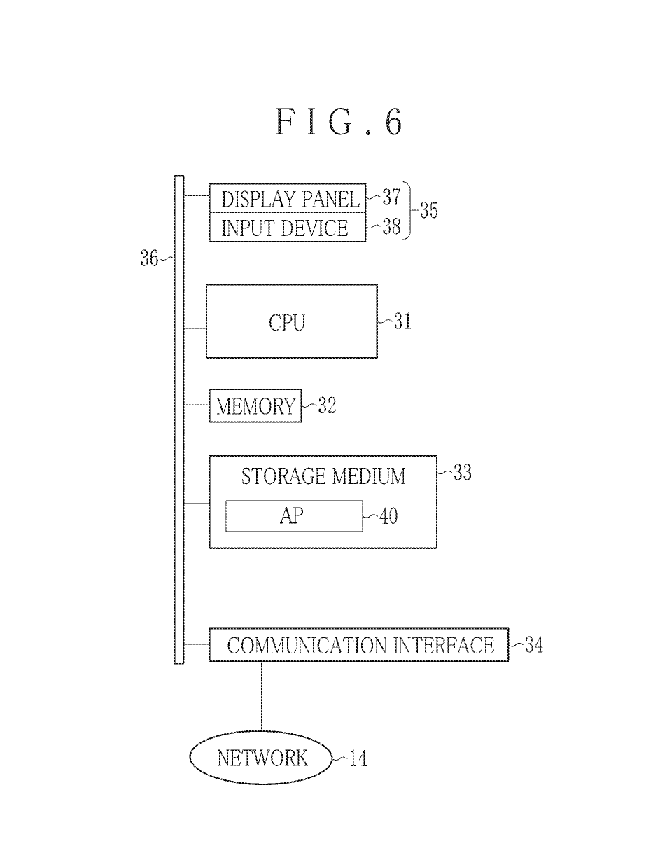

In FIG. 6, each of the medical support server apparatus 11, the server apparatuses 15-17 and the client terminal apparatus 12 is constituted by a computer in an equal manner. Each computer includes a CPU 31, a memory 32, a storage medium 33 or storage device, a communication interface 34 and a user interface 35 for an input/output. A data bus 36 interconnects those circuit devices. The user interface 35 includes a display panel 37 and an input device 38 such as a keyboard and mouse.

An example of the storage medium 33 is a hard disk drive or HDD. An application program 40 as a computer-executable program is stored in the storage medium 33. Also, a disk array having plural HDDs is combined with each of the medical support server apparatus 11, the electronic chart server apparatus 15, the image server apparatus 16 and the scheduling server apparatus 17 by way of the storage medium 33 but separately from the HDD for the program. Note that the disk array can be contained in a server main unit of the server apparatus, but can be externally connected to the server main unit by use of the local area network or LAN as a network.

The memory 32 is a working memory with which the CPU 31 performs tasks, for example, RAM (random access memory). The CPU 31 reads the control program from the storage medium 33, and loads the memory 32 with the control program, to control various elements in the computer by running the control program. The communication interface 34 is a network interface for controlling transmission by use of the network 14.

The client program as the application program 40 is installed in the client terminal apparatus 12. The client program is run in the client terminal apparatus 12 to perform access to the medical support server apparatus 11 for transmitting a request for outputting a medical support page and for creating a medical care schedule, and to receive and display the medical support page from the medical support server apparatus 11 to the client terminal apparatus 12. Note that the client program may be programmed specially for the medical support system 10, or can be a web browser of a widely used type.

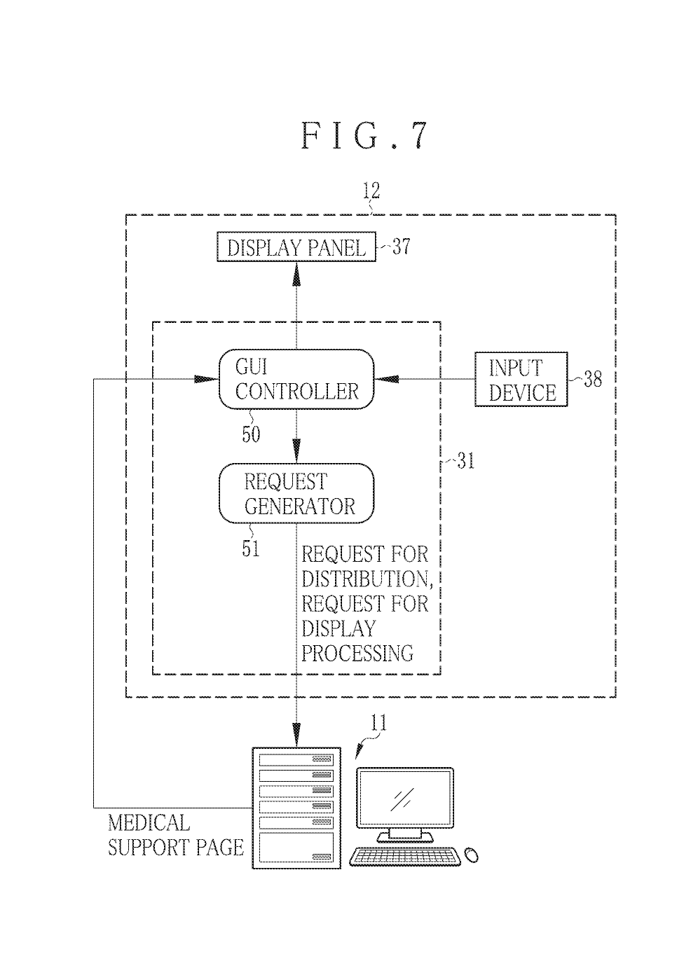

In FIG. 7, the CPU 31 in the client terminal apparatus 12 is caused by running the client program to function with a GUI controller 50 and a request generator 51 or request generation unit, in cooperation with the memory 32. The request generator 51 generates various requests to the medical support server apparatus 11. The display panel 37 in the client terminal apparatus 12 displays a start page (not shown) with functions according to the GUI (graphical user interface).

The GUI controller 50 controls the screen view according to the received inputs from the input device 38 with the start page, such as clicking of screen buttons with a pointer of a mouse. The GUI controller 50 inputs a command signal of a request to the request generator 51 according to the inputs from the input device 38. The request generator 51 generates the request in response to the command signal from the GUI controller 50. The request is input to the medical support server apparatus 11.

A list of functions in the client terminal apparatus 12 is displayed in the start page, in which the functions can be designated selectively for use. In the embodiment, examples of the functions in the client terminal apparatus 12 are creating and viewing an electronic chart, viewing a diagnostic image, creating and viewing a medical care schedule, and the like. Upon selecting one of the functions, a request for readout of a medical support page according to the selected function is transmitted to the medical support server apparatus 11.

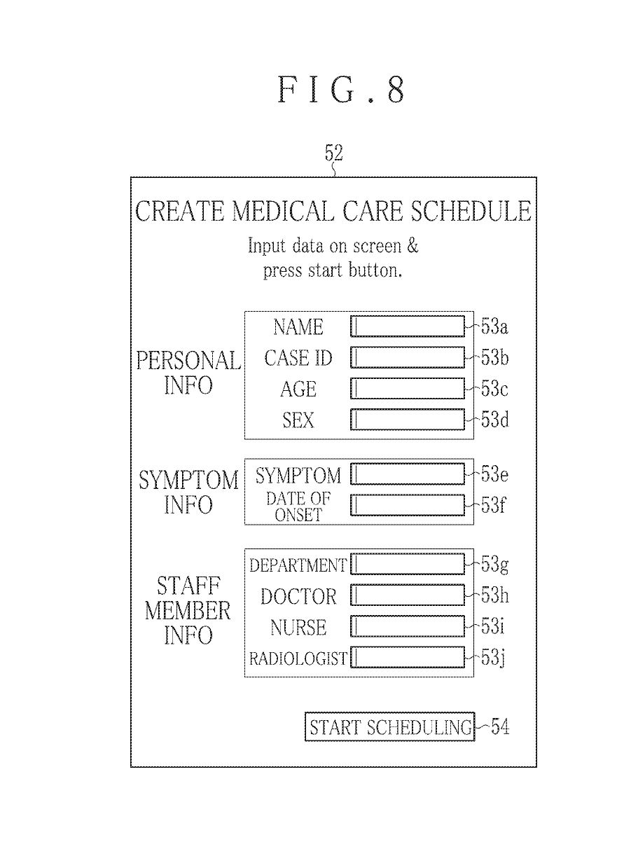

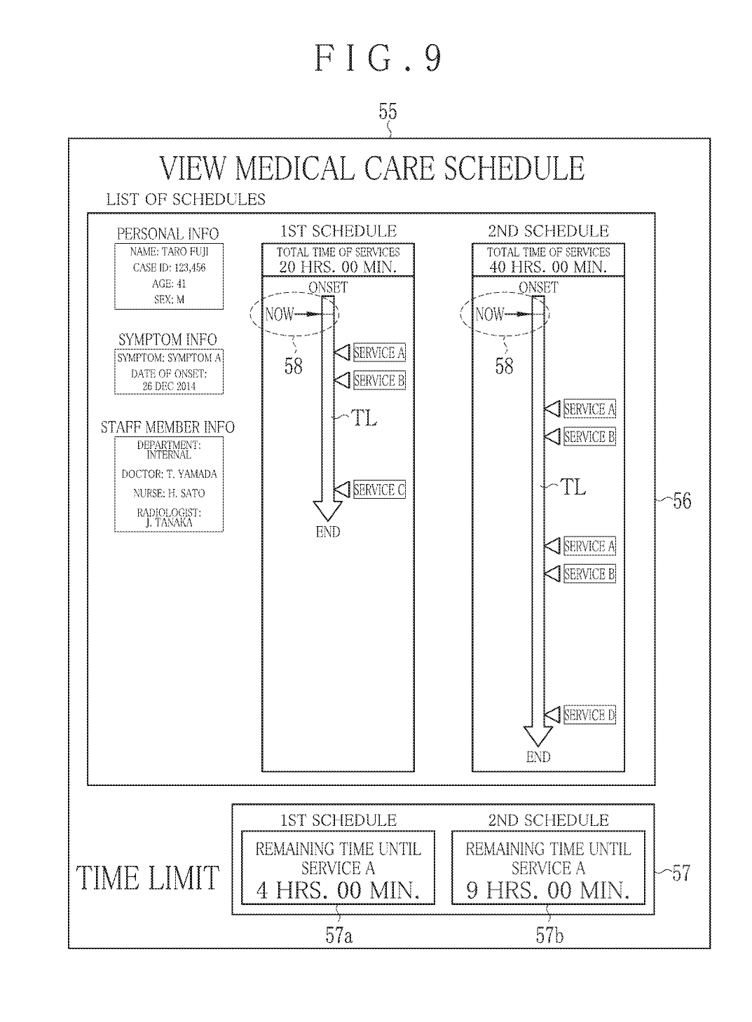

The medical support page is constituted by data described in a markup language, for example, XML (Extensible Markup Language), and has functions of manual operation according to the GUI. In the present embodiment, the medical support page is constituted by an electronic chart page, a diagnostic image page, a scheduling page 52 of FIG. 8, and a schedule view page 55 of FIG. 9. The electronic chart page is used for creating and viewing an electronic chart. The diagnostic image page is used for viewing a diagnostic image. The scheduling page 52 is used for creating and viewing a medical care schedule.

In FIG. 8, the scheduling page 52 is a medical support page transmitted from the medical support server apparatus 11 to the client terminal apparatus 12 after selection of a use of creating and viewing a medical care schedule in the start page. The scheduling page 52 includes input fields 53a-53j and a scheduling button 54. The input fields 53a-53j are used for inputting the information described above. The input fields 53a-53d are patient case fields for inputting case information of a patient body. The input fields 53e and 53f are symptom fields for inputting symptom information of a disease, disorder or injury. The input fields 53g-53j are staff member fields for inputting staff member information in a hospital facility.

In case the input data are input to the input fields 53a-53j and the scheduling button 54 is operated, a request for creating a medical care schedule is generated. The request is transmitted to the medical support server apparatus 11 together with the input data input to the input fields 53a-53j. The medical support server apparatus 11 reads out a reference medical care schedule from the first storage area 20a according to the request in association with the symptom in the input data, and associates the input data with the reference medical care schedule, to create a medical care schedule of the particular patient body of the input data. The medical support server apparatus 11 writes the medical care schedule to the second storage area 20b, and outputs the schedule view page 55 of FIG. 9 according to the created medical care schedule.

In FIG. 9, the schedule view page 55 is a medical support page distributed by the medical support server apparatus 11 to the client terminal apparatus 12 after creating the medical care schedule for the patient body in the scheduling page 52 by inputting important data. A schedule area 56 and a time limit area 57 are disposed in the schedule view page 55.

The schedule area 56 displays medical care schedules of the patient body after creation in the scheduling page 52. The medical care schedules have personal information, symptom information and staff member information. Examples of the personal information are a patient's name, case ID, age and sex. Examples of the symptom information are a name of the symptom (disease, disorder or injury), and a date and time of clinical onset. Examples of the staff member information are a hospital department and name of a doctor or staff member (caregiver). The medical care schedules include first and second medical care schedules arranged in the schedule area 56 in a comparable form. An indicator 58 is displayed with the first and second medical care schedules in the schedule area 56 for elapsed time from the clinical onset. In FIG. 9, a state of lapse of one hour is illustrated. The indicator 58 is positioned to indicate one hour.

The time limit area 57 includes a first time window 57a and a second time window 57b. The first time window 57a displays estimated remaining time until an initial medical service in the first medical care schedule. The second time window 57b displays estimated remaining time until an initial medical service in the second medical care schedule. In FIG. 9, a medical care schedule of a symptom A is illustrated. The critical time T1 from the clinical onset until the medical service A is 5 hours in the first schedule A1 of the symptom A. See FIG. 5A. Also, the critical time T2 is 10 hours in the second schedule A2 of the symptom A. See FIG. 5B. In FIG. 9, a page upon the lapse of one hour from the clinical onset is illustrated. The estimated remaining time in the first time window 57a is 4 hours. The estimated remaining time in the second time window 57b is 9 hours.

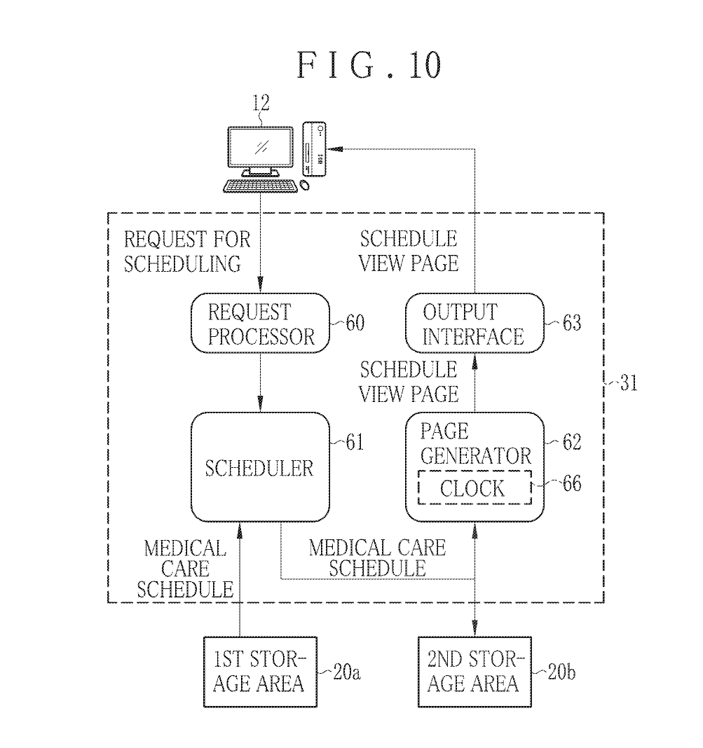

The medical support server apparatus 11 detects a current time point by use of an internal clock device (See FIG. 10), and updates the schedule view page 55 periodically, for example, per one second, with the lapse of time. Then various items are updated, including the estimated remaining time in the time limit area 57, the location of the indicator 58 in the schedule area 56, and the like. Note that it is possible for the client terminal apparatus 12 to update the schedule view page 55 with time.

The estimated remaining time in the first time window 57a is information that medical services can be continued according to the first medical care schedule by performing an initial medical service of the first medical care schedule. The estimated remaining time in the second time window 57b is information that medical services can be continued according to the second medical care schedule by performing an initial medical service of the second medical care schedule.

In the example of FIG. 9, a first medical care schedule A1 in FIG. 5A and a second medical care schedule A2 in FIG. 5B are displayed for the symptom A. Both initial medical services in the first medical care schedule A1 and in the second medical care schedule A2 are a medical service A. Performing the medical service A in the estimated remaining time displayed in the first time window 57a makes it possible to perform subsequent medical services according to the medical care schedule A1. Should the medical service A be not performed (non-occurrence) even until the expiration of the estimated remaining time in the first time window 57a, then the medical service A is performed in the estimated remaining time indicated in the second time window 57b with changeover, before subsequent medical services are performed according to the medical care schedule A2.

Thus, medical services according to the medical care schedule are possible by indication in the schedule view page 55 for the medical care schedule and estimated remaining time until performing the initial medical service (particular medical service) in the medical care schedule. Also, the first medical care schedule with high rapidity is displayed and arranged in the schedule view page 55 with the second medical care schedule with sufficient time but lower rapidity than the first medical care schedule. Important data for medical service with high rapidity can be indicated for facilitated recognition, to increase the rapidity in the medical service.

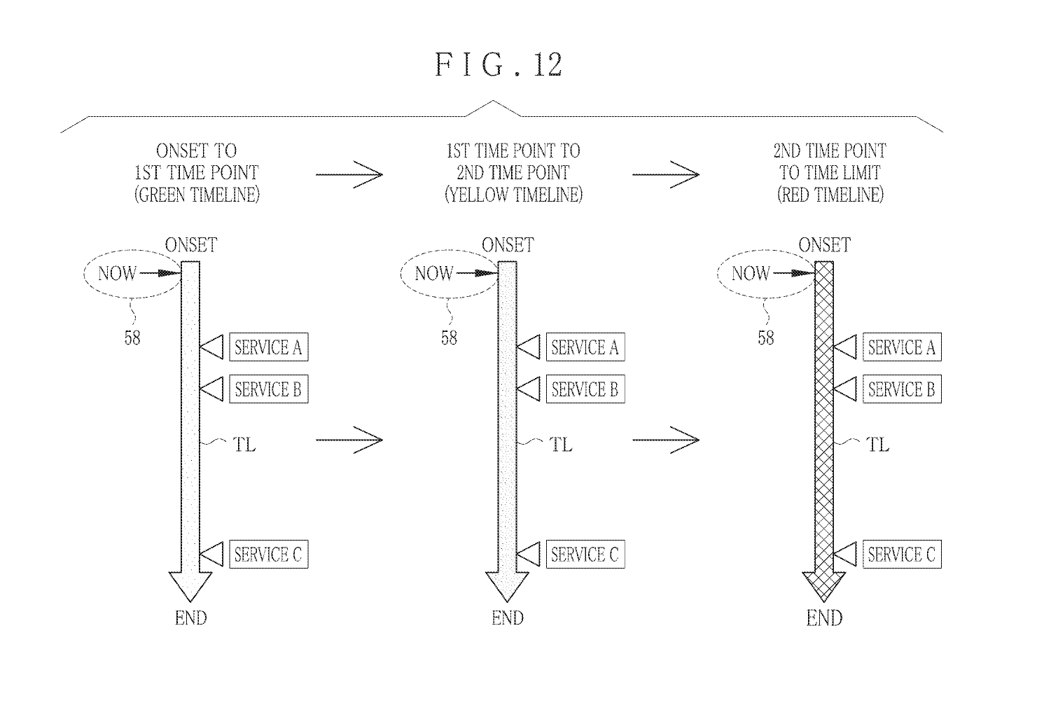

In FIG. 12, the server program is installed in the medical support server apparatus 11 byway of the application program. 40. The CPU 31 in the medical support server apparatus 11 is caused by running the server program to cooperate with the memory 32, to function a request processor 60, a scheduler 61, a page generator 62 or display processor and an output interface 63 or output control device.

The request processor 60 receives a request for creating a medical care schedule according to an input from the client terminal apparatus 12, and inputs the received request to the scheduler 61.

The scheduler 61 reads out a reference medical care schedule from the first storage area 20a in correspondence with the input data (personal information, symptom information and staff member information) designated with the request from the client terminal apparatus 12. The scheduler 61 associates the medical care schedule with the input data, and creates the medical care schedule for the particular patient body according to the input data. The created medical care schedule is stored in the second storage area 20b, and transmitted to the page generator 62.

Upon receiving the input of the medical care schedule from the scheduler 61, the page generator 62 determines a display location of the indicator 58 (in FIG. 9) in the schedule area 56, according to data including a date and time of the clinical onset of the symptom in the input schedule, critical times T1 and T2 from the clinical onset until an initial medical service, and current time point detected by an internal clock device 66. Also, the page generator 62 determines estimated remaining time in the time limit area 57, namely, estimated remaining time until an initial medical service in the first medical care schedule, and estimated remaining time until a second medical service in the second medical care schedule. Then the schedule view page 55 of FIG. 9 is generated from the input medical care schedule, determined location of the indicator 58 and determined estimated remaining time. The page generator 62 changes the location of the indicator 58 and the estimated remaining time indicated in the time limit area 57 according to the flow of time, to update the schedule view page 55.

The schedule view page 55 is provided to the output interface 63 after generation and updating in the page generator 62. The output interface 63 outputs the schedule view page 55 to the client terminal apparatus 12 upon reception from the page generator 62. The client terminal apparatus 12 causes the display panel 37 to display the schedule view page 55.

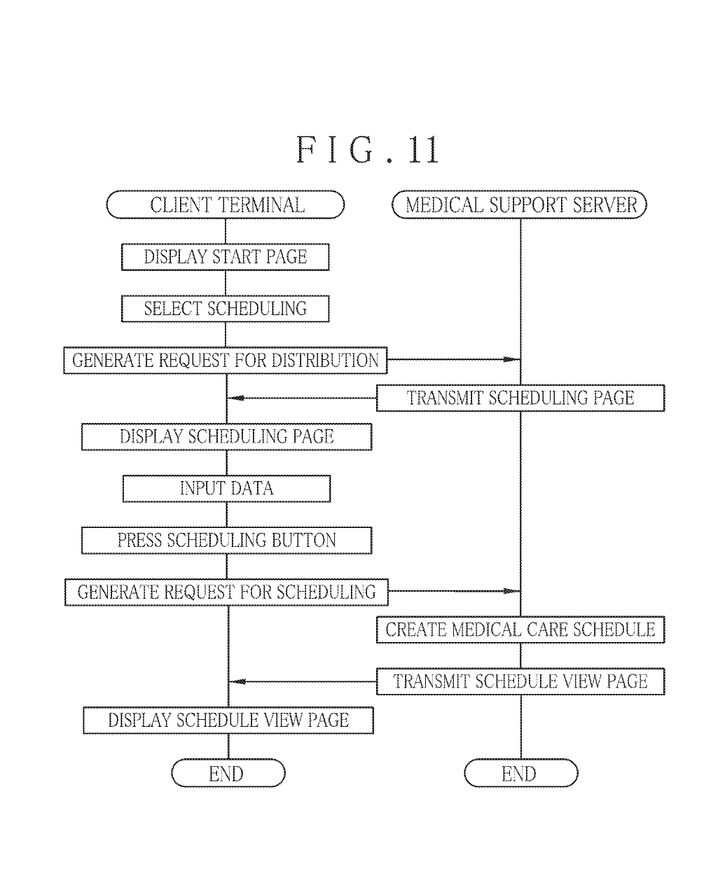

The operation of the above construction is described now by referring to FIG. 11. To create a new medical care schedule (patient workflow), the start page is displayed by running the client program in the client terminal apparatus 12. A function of creating and viewing the medical care schedule is manually designated in the start page. The client terminal apparatus 12 generates a request for distributing the scheduling page 52, and inputs the request to the medical support server apparatus 11.

Upon receiving the request, the medical support server apparatus 11 outputs the scheduling page 52 to the client terminal apparatus 12. A user or operator manually inputs input data (personal information, symptom information and staff member information) with the scheduling page 52, and presses the scheduling button 54. Then a request for scheduling is generated and input to the medical support server apparatus 11.

The medical support server apparatus 11 reads out a medical care schedule from the first storage area 20a in association with a symptom input as important data, and associates the read medical care schedule with the important data, to create the medical care schedule for the particular patient body. Also, the medical support server apparatus 11 generates the schedule view page 55 for indicating the created medical care schedule, and distributes the schedule view page 55 to the client terminal apparatus 12.

The schedule view page 55 distributed by the medical support server apparatus 11 is displayed on the display panel 37 of the client terminal apparatus 12. The schedule view page 55 indicates the medical care schedule and the estimated remaining time until the particular medical service included in the medical care schedule (initial medical service), so that a doctor or caregiver can perform the medical service by utilizing the information. In the schedule view page 55, the first and second medical care schedules with different features are arranged in a comparable manner. Values of the estimated remaining time until the required medical service (initial medical service) for each of the first and second medical care schedules are displayed. This is effective in notifying medical services for improving rapidity in the medical care.

In the embodiment, the initial medical service in the medical care schedule is the particular medical service, so that estimated remaining time until the particular medical service is indicated. However, the invention is not limited to this structure. The particular medical service can be a second or later medical service among plural medical services in the medical care schedule. Also, plural medical services in the medical care schedule can be set as a plurality of particular medical services. Furthermore, it is possible for a user to select one of the medical services as a particular medical service.

In the above embodiment, both of the first and second medical care schedules are displayed. However, only one of the first and second medical care schedules may be displayed in the schedule view page. The estimated remaining time until the particular medical service in the displayed medical care schedule can be displayed, for use as a reference in performing the medical care schedule.

Also, three or more medical care schedules can be displayed in a comparable manner. To this end, the first storage area 20a stores three or more medical care schedules for one symptom as reference medical care schedules. For the particular patient body, three or more medical care schedules are created according to the reference medical care schedules in the first storage area 20a. The schedule view page inclusive of the three or more medical care schedules being created is generated by the page generator 62, and can be distributed to the client terminal apparatus 12 by the output interface 63.

In the above embodiment, the reference medical care schedules stored in the first storage area 20a are associated with the symptoms. However, the invention is not limited to the embodiment. Medical care schedules should be prepared with changes suitably, not only for the various symptoms but also for an age, sex, medical history and other attributes of a patient. For example, a medical care schedule for a given symptom can include a medical service of one time of use of a drug on a condition of a young patient. However, a medical care schedule for the same symptom should include a medical service of plural times of use of the same drug at a smaller dose on a condition of an aged patient with physical weakness. It is possible to store plural predetermined reference medical care schedules in the first storage area 20a for one given symptom but in consideration of the age, sex, medical history and other attributes of a patient. A medical care schedule for a patient can be created by use of the reference medical care schedules according to the patient's condition.

In the above embodiment, an initial medical service is performed within the critical time T1 from the clinical onset in order to perform the medical services in the first medical care schedule. However, it is conceivable that a succeeding medical service cannot be performed in the first medical care schedule or should not be performed in the first medical care schedule, due to a delay in performing such a succeeding medical service even after performing the initial medical service within the critical time T1 from the clinical onset. In view of this problem, time limits from a clinical onset can be preferably determined for respectively two or more of the medical services in the first medical care schedule. At each time of completing one of the medical services in time for the time limit, estimated remaining time until a second time limit can be displayed.

In the second medical care schedule, similarly, time limits from a clinical onset (or preceding medical service) can be preferably determined for respectively two or more of the medical services. At each time of completing one of the medical services with the time limit, estimated remaining time until a second time limit can be displayed.

Note that a difference may occur between plural service flows according to the second medical care schedule. In the first one of the service flows, the second medical care schedule is after non-occurrence (unsuccessful result) of the initial medical service in the first medical care schedule in time for the time limit. In the second one of the service flows, the second medical care schedule is after a successful result of the initial medical service in the first medical care schedule in time for the time limit, but after non-occurrence (unsuccessful result) of a succeeding medical service in the first medical care schedule in time for the time limit. In view of this, it is possible to store a plurality of types of the second medical care schedule in the first storage area 20a according to time points of non-occurrence (unsuccessful result) of medical service according to the first medical care schedule. The second medical care schedule of the displayed type can be changed over to a second medical care schedule of another type for non-occurrence of the succeeding medical service in time for the time limit, at each time after the medical service is performed according to the first medical care schedule.

In the above embodiment, screen views of the first and second medical care schedules are contained in a single view page. However, the invention is not limited to this structure. For example, the schedule area 56 in FIG. 9 can be displayed in a scrollable manner in upward and downward directions. The entirety of the medical care schedules can be viewed by scrolling the schedule area 56.

Also, a display size of the schedule area 56 can be changeable. For example, an enlargement button and a reduction button are additionally displayed in the schedule area 56. The enlargement button is used for enlarging the size of the medical care schedule. The reduction button is used for reducing the size of the medical care schedule. The page generator 62 can update the information of the schedule view page 55 for an enlarged size in response to manual operation of the enlargement button, or for a reduced size in response to manual operation of the reduction button.

Furthermore, a display form of the schedule view page 55 can be changed according to the estimated remaining time. For example, display color of the medical care schedule can be set changeable as illustrated in FIG. 12. For example, green is used for indicating the timeline TL during a first period (1 hour) from the clinical onset. Yellow is used for indicating the timeline TL during a second period (2 hour) from the lapse of the first period. Red is used for indicating the timeline TL from the lapse of the second period until the time limit (estimated time point upon the lapse of 3 hours). Note that elements similar to those in FIG. 12 are designated with identical reference numerals.

It is also possible to change over a display color of a portion of the timeline TL according to the estimated remaining time instead of changing the display color of the entirety of the timeline TL. An example of the portion is a section from the clinical onset to the time limit of the particular medical service. Furthermore, it is possible to change over the timeline TL from indication of a continuous turn-on to indication of winking, and to decrease an interval of the winking of the timeline TL according to shortness of the estimated remaining time. Also, it is possible to change over a display form of a portion other than the timeline TL. Examples of the other portion can be a background behind the timeline TL and the time limit area. Examples of the display form can be a display color, time interval of winking, display layout and the like. Furthermore, changeover of the display form can be set differently between the types of the particular medical service. For example, the area for the medical care schedule A is changed over to a red color in case the estimated remaining time becomes as small as one (1) hour or less. However, an area for the medical care schedule B is not changed over to the red color even in case the estimated remaining time becomes as small as one (1) hour or less, and is changed over to the red color even in case the estimated remaining time becomes as small as 30 minutes or less.

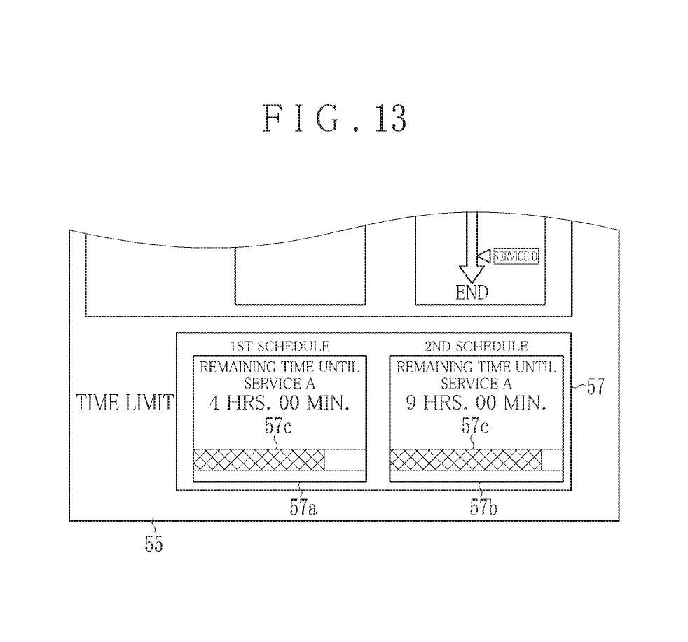

In the above embodiment, the estimated remaining time is indicated numerically such as 4:00 in FIG. 9. However, it is possible graphically to indicate the estimated remaining time. For example, a time bar 57c in FIG. 13 is indicated in the first or second time window 57a or 57b in the schedule view page 55 to express the estimated remaining time. The time bar 57c has a size decreasing gradually from the clinical onset, so that its right end gradually moves to the left. Upon becoming of the estimated remaining time to zero (0), the time bar 57c is deleted by reach of the right end to the left end. Consequently, graphical representation of the estimated remaining time makes it possible to recognize the estimated remaining time easily. Note that only the time bar 57c can be indicated in the first or second time window 57a or 57b.

### Second Embodiment

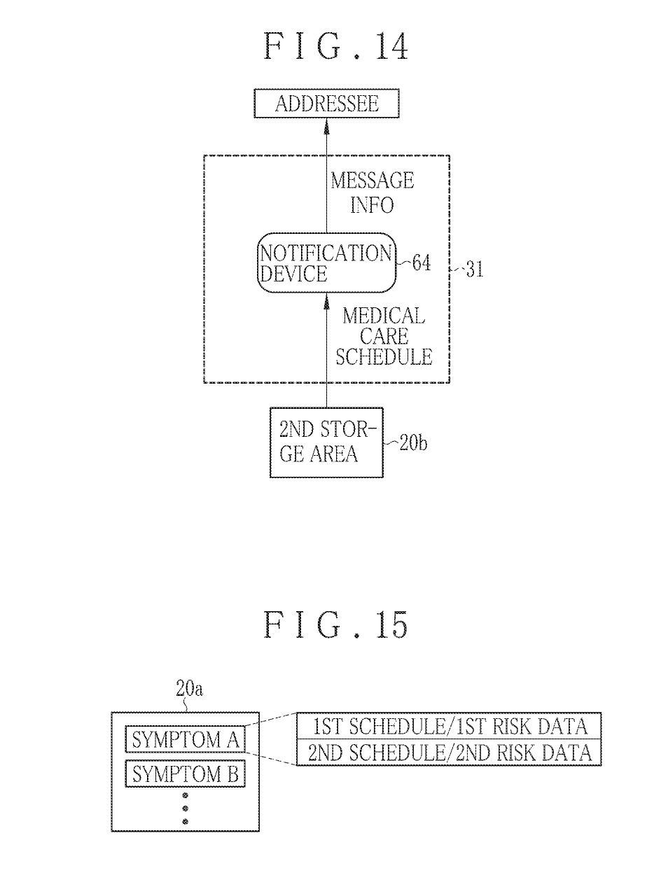

In contrast with the first embodiment of FIG. 9 in which the schedule view page 55 displays the estimated remaining time, information of estimated remaining time is informed to a predetermined addressee in a second embodiment of FIG. 14, so as to support performing of a particular medical service on the basis of a medical care schedule.

In FIG. 14, a notification device 64 is caused to function in the CPU 31 of the medical support server apparatus 11 in addition to the request processor 60, the scheduler 61, the page generator 62 and the output interface 63. The notification device 64 refers to the medical care schedules (patient workflows) stored in the second storage area 20b, namely the medical care schedules for the particular patient body, and checks whether there is a medical care schedule of which the estimated remaining time until the particular medical service is less than reference time, for example, one hour.

Assuming that a medical care schedule of which the estimated remaining time is shorter than the reference time is detected, then the notification device 64 notifies a predetermined addressee of the estimated remaining time until the particular medical service, or of message information that the estimated remaining time has become shorter than the reference time. An example of the addressee is a terminal apparatus for use by a staff member of the medical care schedule of which the estimated remaining time is shorter than the reference time, among the client terminal apparatuses 12. An example of the staff member is a doctor or operator (caregiver) in charge of the medical care. Information of the staff member is input as important data for creating the medical care schedule and associated with the medical care schedule. The staff member can be recognized by referring to the medical care schedule. In the second embodiment, the estimated remaining time is notified, so that support for the particular medical service by following the medical care schedule can be enhanced.

Furthermore, it is possible to change over the addressee or form of notice according to the estimated remaining time or type of the particular medical service. For example, in case the estimated remaining time becomes less than 2 hours, message information is notified only to a nurse, technician (radiologist) and other staff members (caregivers) without notifying to a doctor. In case the estimated remaining time becomes less than 1 hour, message information is notified to all the relevant staff members inclusive of the doctor. Otherwise, before the estimated remaining time becomes less than 2 hours, message information can be notified for one time per one hour. Before the estimated remaining time becomes less than 1 hour, message information can be notified for one time per 10 minutes. Furthermore, assuming that a particular medical service is administration of a drug (as a treatment), message information can be notified only to a nurse. Assuming that a particular medical service is examination (as a diagnosis) of a patient body, message information can be notified only to a technician (radiologist) of the examination.

### Third Embodiment

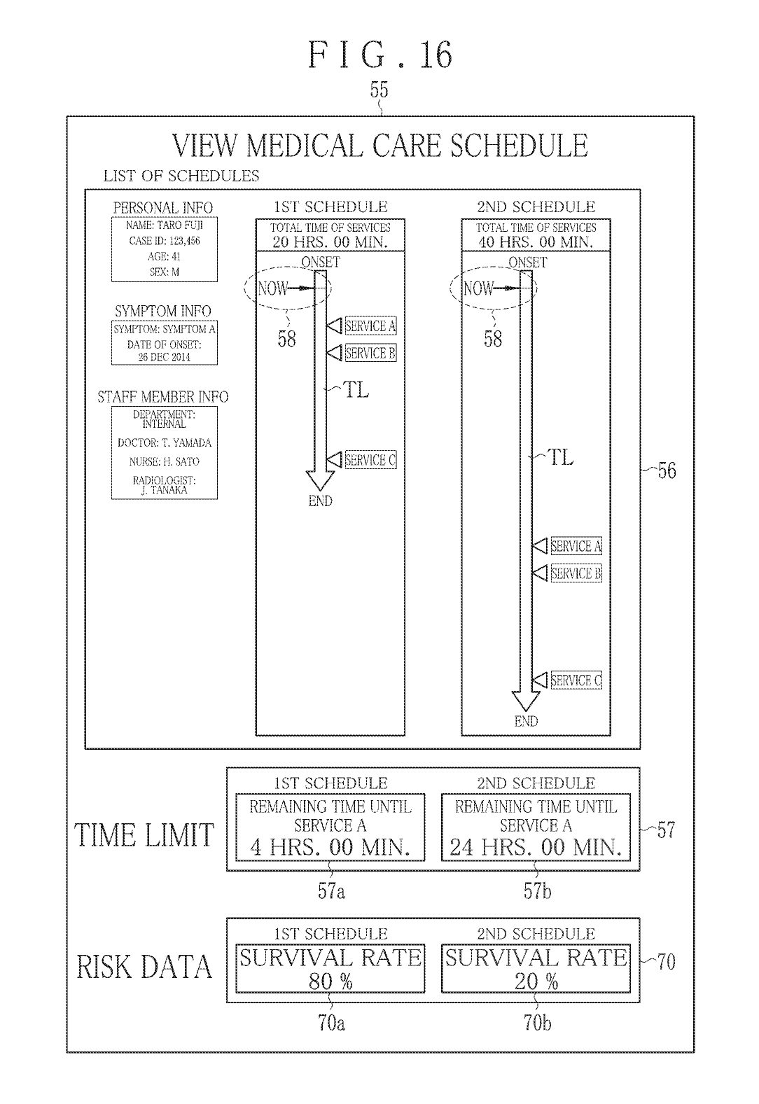

Risk to a patient estimated for each of first and second medical care schedules is indicated as illustrated in FIGS. 15 and 16, in addition to the structure of the first embodiment of displaying the estimated remaining time in connection with the first and second medical care schedules in FIG. 9.

In FIG. 15, first risk data is associated with the first medical care schedule (patient workflow) stored in the first storage area 20a of the schedule database 20 for expressing risk estimated to a patient body after a medical service in the first medical care schedule. Second risk data is associated with the second medical care schedule for expressing risk estimated to a patient body after a medical service in the second medical care schedule. Examples of the first and second risk data are information of a survival rate after the medical service, success rate of treatment, adverse effect of treatment, and the like.

In FIG. 16, a medical care schedule for a particular patient body in the third preferred embodiment is created by use of the first and second medical care schedules inclusive of the first and second risk data, and is displayed in the schedule area 56 of the schedule view page 55 in a comparable manner. In FIG. 16, data related to the medical service (number and types of medical services, and their combinations) are the same between the first and second medical care schedules. However, the initial medical service A as particular medical service is started later in the second medical care schedule than in the first medical care schedule by 20 hours.

A risk display area 70 is disposed in the schedule view page 55 in FIG. 16. The risk display area 70 has first risk score data 70a and second risk score data 70b. The first risk score data 70a (risk information) are in the first medical care schedule. The second risk score data 70b (risk information) are in the second medical care schedule. A survival rate of 80% is the first risk score data 70a as an estimated result of a medical service in the first medical care schedule. A survival rate of 20% is the second risk score data 70b as an estimated result of a medical service in the second medical care schedule.

In comparison by referring to FIG. 16, there is no difference in the rapidity in the medical services between the first and second medical care schedules, because the medical services are the same between those. However, in consideration of risk to the patient, the risk in the second medical care schedule is higher (with a lower survival rate) because a time point of the initial medical service A is later. In short, changes are likely to occur in the risk to the patient due to a difference in the time point even with the same medical services to be performed. In the third embodiment, it is possible to perform the medical service in a medical care schedule of lower risk, as the risk to the patient is displayed for medical services in each of the first and second medical care schedules.

Note that the system in the various embodiments is a client-server system in which a schedule view page is transmitted from the medical support server apparatus to the client terminal apparatus with the network. The medical support server apparatus corresponds to the medical support apparatus. Furthermore, it is possible to construct a client terminal apparatus as a medical support apparatus in place of the client-server system. For this purpose, a CPU in the client terminal apparatus is operated as a request receiver, page generator and output interface. The request receiver receives an input from an input device of the client terminal apparatus. The output interface outputs the schedule view page from the page generator to a display of the client terminal apparatus. Although the output interface in the client-server system outputs information from the medical support server apparatus to the client terminal apparatus, the client terminal apparatus by way of the medical support apparatus has the output interface for outputting to the display of the client terminal apparatus.

In the above embodiments, the timeline representation is an axial bar portion having a predetermined width and extending vertically. However, the timeline representation of the invention is not limited. For example, a timeline representation can be a timeline having an axis line and scale graduations arranged on the axis line, a series of dots, a series of numerals, and also a timeline representation having horizontally extending thin straight lines arranged in parallel with one another at a predetermined interval, to express time ranges by splitting areas in the vertical direction.

The medical support apparatus of the invention is remarkably useful in situations of medical care with high urgency, for example, care for acute disease with a fit or injury by an accident, to require emergency medicine, emergency surgery, and the like.

In the description heretofore, medical care or medical service includes diagnosis (questionnaire, work-up and/or examination) and treatment. For symptoms of numerous cases, a medical care schedule (patient workflow) includes treatment. However, a patient body may be diagnosed only with a benign state of a symptom to require simply observation of progress. For this condition, a medical care schedule can include only diagnosis (questionnaire, work-up and/or examination) without including treatment.

Although the medical support apparatus is constructed for medical use, it is possible to known techniques of a workflow system or a timer for general use, in combination with the feature of the present invention.

The present invention is not limited to the above embodiments. Various features of the embodiments and variants of the invention can be combined with each other suitably. Also, the computer-executable program and a storage medium for storing the computer-executable program are included in the scope of the present invention.

According to one embodiment mode of the invention, a non-transitory computer readable medium for storing a computer-executable program is provided, the computer-executable program enabling execution of computer instructions to perform operations for medical support for outputting information of a medical service to a patient body. The operations include producing a schedule view page to display a medical care schedule constituted by arranging plural medical services in a time sequence. The operations include displaying estimated remaining time in the schedule view page, the estimated remaining time being time from a current time point until an estimated time point of at least one particular medical service selected from the medical services in the medical care schedule.

Also, a user interface for medical support for outputting information of a medical service to a patient body is provided, and includes an area for displaying a schedule view page to display a medical care schedule constituted by arranging plural medical services in a time sequence. An area is for displaying estimated remaining time in the schedule view page, the estimated remaining time being time from a current time point until an estimated time point of at least one particular medical service selected from the medical services in the medical care schedule.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A medical support apparatus for outputting information of a medical service to a patient body, comprising:
a page generator for generating a schedule view page to display a medical care schedule constituted by arranging plural medical services in a time sequence;
wherein said page generator further performs display processing to display estimated remaining time in said schedule view page, said estimated remaining time being time from a current time point until an estimated time point of at least one particular medical service selected from said medical services in said medical care schedule.

2. A medical support apparatus as defined in claim 1, wherein said page generator changes a display form of said schedule view page according to said estimated remaining time.

3. A medical support apparatus as defined in claim 2, wherein said page generator changes said display form of said schedule view page by changing a display form of a timeline representation.

4. A medical support apparatus as defined in claim 2, wherein at least one predetermined time value is predetermined in association with a type of said particular medical service;
said page generator changes said display form in case said estimated remaining time becomes equal to or less than said predetermined time value.

5. A medical support apparatus as defined in claim 4, further comprising a notification device for notifying message information in case said estimated remaining time becomes equal to said predetermined time value.

6. A medical support apparatus as defined in claim 5, wherein said predetermined time value is constituted by plural time values between which an interval gradually decreases, and a number of times of notifying said message information increases with a decrease of said interval.

7. A medical support apparatus as defined in claim 1, wherein said medical care schedule in said schedule view page is constituted by:
a first medical care schedule having a medical service to be performed in case said particular medical service is in time until said estimated time point;
a second medical care schedule having a medical service to be performed in case of non-occurrence of said particular medical service in time until said estimated time point.

8. A medical support apparatus as defined in claim 1, wherein said page generator further performs display processing of first and second risk data in said schedule view page;
said first risk data is data of risk to said patient body estimated in case said particular medical service is in time until said estimated time point;
said second risk data is data of risk to said patient body estimated in case of non-occurrence of said particular medical service in time until said estimated time point.

9. A medical support apparatus as defined in claim 8, wherein said first and second risk data are data of at least one of a survival rate of said patient body, a success rate of treatment of said patient body, and adverse effect of said treatment.

10. A medical support apparatus as defined in claim 1, wherein information of said estimated remaining time is at least one of numerical information and graphical information.

11. A medical support apparatus as defined in claim 1, further comprising a scheduler for creating said medical care schedule according to a reference medical care schedule and information of said patient body.

12. A medical support apparatus as defined in claim 11, wherein said reference medical care schedule is constituted by plural reference medical care schedules predetermined in a selectable manner in relation to at least one of a symptom, age, sex and medical history of said patient body.

13. A medical support apparatus as defined in claim 1, wherein said medical care schedule is constituted by at least first to third medical care schedules;
said first medical care schedule is used initially for performing said particular medical service;
said second medical care schedule is used by changeover in case said particular medical service in said first medical care schedule is in time until said estimated time point;
said third medical care schedule is used by changeover in case of non-occurrence of said particular medical service in said first medical care schedule in time until said estimated time point.

14. A medical support system including a client terminal apparatus, and a medical support apparatus for outputting information of a medical service to a patient body in response to a request input by said client terminal apparatus, said medical support system comprising:
said medical support apparatus including:
a page generator for generating a schedule view page to display a medical care schedule constituted by arranging plural medical services in a time sequence;
wherein said page generator further performs display processing to display estimated remaining time in said schedule view page, said estimated remaining time being time from a current time point until an estimated time point of at least one particular medical service selected from said medical services in said medical care schedule.

15. A medical support method for outputting information of a medical service to a patient body, comprising steps of:
generating a schedule view page to display a medical care schedule constituted by arranging plural medical services in a time sequence;
displaying estimated remaining time in said schedule view page, said estimated remaining time being time from a current time point until an estimated time point of at least one particular medical service selected from said medical services in said medical care schedule.
